(19) United States
(12) Patent Application Publication
(10) Pub. No.: US 2025/0260425 A1
(43) Pub. Date: Aug. 14, 2025

(54) ANALOG WIDEBAND AND DIGITAL NARROWBAND HYBRID BEAM STEERING

(71) Applicant: Telefonaktiebolaget LM Ericsson (publ), Stockholm (SE)

(72) Inventors: Lars Sundström, Lund (SE); Fredrik Tillman, Lund (SE); Staffan Ek, Lund (SE)

(21) Appl. No.: 18/859,835

(22) PCT Filed: Apr. 26, 2022
(86) PCT No.: PCT/EP2022/061045

§ 371 Date: Oct. 24, 2024

(51) Int. Cl. H04B 1/10; H04B 1/00; H04B 7/06

(52) U.S. Cl. CPC H04B 1/10; H04B 1/0096; H04B 7/0617

(57) ABSTRACT

Systems and methods are disclosed for hybrid analog wideband beam steering and digital narrowband beam steering. In one embodiment, a receiving node for a wireless system comprises antenna elements or antenna sub-arrays and receive branches each comprising a radio front-end (RFE), a phase-locked loop (PLL), down-conversion circuitry, filtering circuitry, and analog-to-digital conversion (ADC) circuitry. The RFE has an input coupled to a respective one of the plurality of antennas and outputs a wideband radio frequency (RF) signal. The down-conversion circuitry down-converts the wideband RF signal to baseband based on a PLL output of the PLL. The filtering circuitry filters the wideband baseband signal, wherein the filtered wideband baseband signal comprises a narrowband signal. The ADC circuitry converts the narrowband signal or a modified version thereof to digital. The PLLs of the plurality of receive branches are configured to apply respective phase rotations for wideband analog beam steering.

### TECHNICAL FIELD

The present disclosure relates to analog beam steering at a receiving node in a wireless system.

### BACKGROUND

To improve a radio link budget several techniques can be deployed. Among the most obvious ones include removing of impairments that block or diminish the transmission, increasing the transmit output power level, and increasing receiver sensitivity. However, from a mobile telecommunications system perspective, these remedies will not suffice. Line-of-sight (LOS) conditions cannot be guaranteed, and regulatory emission requirements put a cap on radiated output power levels. In addition, the receiver sensitivity and selectivity are, to a large degree, set by physical limitations such as those of integrated circuit (IC) technology and passive filters. To combat these limitations, increasing the antenna gain is the remaining option, and thus it is common practice for high performing radio links to implement mechanisms for increasing the antenna gain.

One way to increase the antenna gain is by increasing the antenna directivity. In other words, by increasing the effective antenna aperture (e.g., using multiple antennas elements placed in an array), the pathloss is decreased, and thus antenna gain is increased, thanks to increased antenna directivity. A common technique to implement antenna directivity is analog phase-steering. Analog phase-steering creates constructive interference between signals from several low-gain antennas to create a desired antenna beam. The antenna beam is steered by adjusting the real-time delay (or equivalent phase weights) in each transceiver branch in the array, and the field strength obtained in the wanted direction is called the “main lobe” or “main beam”. One example of beam steering is shown in FIG. 1.

One challenge with beam steering is that energy is directed spatially towards a receiver, and thus the direction must be known by the transmitter. In addition, if beam steering is also used on the receiving end, the angle of the incoming radio wave must be known. These characteristics force the radio system (i.e., transmitter and receiver) to keep track of the physical direction of the communication and, in a mobility context, constantly monitor spatial changes, i.e. perform beam scanning. This may result in capacity reductions or increased latencies depending on implementation, as increasingly larger arrays lead to an increased search space, i.e. more beam angles of arrival to monitor.

In commercial analog phased-array telecommunications beam steering systems today, the common practice is to scan through a pre-determined pattern of possible beam angles, i.e., a grid of beams. Algorithms to perform this task may include changing the beamwidth incrementally to lower the search space or deploy a specific search sequence based on history or machine learning. However, the principles remain the same, i.e., try out beam angles in a sequence and determine the direction of the incoming wave.

As mentioned above, performing a sequential search of a large number of possible beam angles consumes time and radio resources and therefore lowers the overall system performance. This is especially pronounced for phase-steering as only one beam angle can be deployed at each time instant. In a high mobility scenario, this drawback degrades performance even more as the beam scan update frequency must increase.

### SUMMARY

Systems and methods are disclosed for hybrid analog wideband beam steering and digital narrowband beam steering. In one embodiment, a receiving node for a wireless system comprises a plurality of antenna elements or antenna sub-arrays and a plurality of receive branches. Each receive branch of the plurality of receive branches comprises a radio front-end (RFE), a phase-locked loop (PLL), down-conversion circuitry, filtering circuitry, and analog-to-digital conversion (ADC) circuitry. The RFE has an input coupled to a respective one of the plurality of antennas or antenna sub-arrays and an output. The RFE is configured to output a wideband radio frequency (RF) signal at the output of the RFE, the wideband RF signal comprising a narrowband RF signal. The PLL is configured to provide a PLL output, and the down-conversion circuitry is configured to down-convert the wideband RF signal to baseband based on the PLL output of the PLL to thereby provide a wideband baseband signal for the receive branch, the wideband baseband signal comprising a narrowband signal that is a baseband version of the narrowband RF signal comprised in the wideband RF signal. The filtering circuitry is configured to filter the wideband baseband signal for the receive branch to attenuate in-band and out-of-band interference and thereby provide a filtered wideband baseband signal for the receive branch, wherein the filtered wideband baseband signal for the receive branch comprises the narrowband signal. The ADC circuitry is configured to convert the narrowband signal or a modified version thereof from analog to digital, thereby providing a digital narrowband signal for the receive branch. The PLLs of the plurality of receive branches are configured to apply respective phase rotations for wideband analog beam steering. In this manner, background beam estimation, or scanning, is enabled without interruption of regular reception or transmission. In addition, frequent updating of beam steering weights used for wideband analog beamforming is enabled.

In one embodiment, the receiving node further comprising digital processing circuitry configured to receive the digital narrowband signals provided by the plurality of receive branches and perform, based on the digital narrowband signals provided by the plurality of receive branches, a narrowband beam scan procedure by which a plurality of beam directions are simultaneously scanned and one of the plurality of beam directions is selected. In one embodiment, the phase rotations applied by the PLLs are configured to apply wideband analog beam steering in the one of the plurality of beam directions selected by the digital processing circuitry. In another embodiment, each receive branch of the plurality of receive branches further comprises phase rotation circuitry configured to apply a second phase rotation to the digital narrowband signal for the receive branch, the second phase rotation being the opposite of the phase rotation applied by the respective PLL. In one embodiment, during reception of a subsequent wideband signal, the phase rotations applied by the PLLs of the plurality of receive branches are configured to receive the subsequent wideband signal at the one of the plurality of beam directions selected by the digital processing circuitry.

In one embodiment, the narrowband signal that is at a frequency offset from DC, each receive branch of the plurality of receive branches further comprises frequency-shifting circuitry configured to frequency-shift the narrowband signal to DC to thereby provide a frequency-shifted narrowband signal, and the ADC circuitry is configured to convert the frequency-shifted narrowband signal from analog to digital, thereby providing the digital narrowband signal for the receive branch. In one embodiment, the frequency-shifting circuitry comprises a complex intermediate frequency (IF) harmonic rejection mixer. In one embodiment, a frequency-shift applied by the frequency-shift circuitry is configurable.

In one embodiment, the receiving node is a base station. In another embodiment, the receiving node is a wireless communication device.

Corresponding embodiments of a method performed by a receiving node are also disclosed. In one embodiment, a method performed by a receiving node for a wireless system wherein the receiving node comprises a plurality of antenna elements or antenna sub-arrays and a plurality of receive branches comprises, for each receive branch of the plurality of receive branches: receiving a wideband RF signal via a respective antenna element or antenna sub-array, the wideband RF signal comprising a narrowband RF signal; down-converting the wideband RF signal to baseband based on an output of a separate PLL for the receive branch to thereby provide a wideband baseband signal for the receive branch, the wideband baseband signal comprising a narrowband signal that is a baseband version of the narrowband RF signal comprised in the wideband RF signal; filtering the wideband baseband signal for the receive branch to attenuate in-band and out-of-band interference and thereby provide a filtered wideband baseband signal for the receive branch, the filtered wideband baseband signal for the receive branch comprising the narrowband signal; and converting the narrowband signal or a modified version thereof from analog to digital, thereby providing a digital narrowband signal for the receive branch. Wideband analog beam steering is applied via configuration of phase rotations of the PLL outputs of the PLLs of the plurality of receive branches.

In one embodiment, the method further comprises performing, based on the digital narrowband signals provided by the plurality of receive branches, a narrowband beam scan procedure by which a plurality of beam directions are simultaneously scanned and one of the plurality of beam directions is selected. In one embodiment, the method further comprises applying analog beam steering in the one of the plurality of beam directions selected by the digital processing circuitry via configuration of the phase rotations of the separate PLLs. In one embodiment, the method further comprises, for each receive branch of the plurality of receive branches, applying a second phase rotation to the digital narrowband signal for the receive branch that is the opposite of the phase rotation applied by the separate PLL for the receive branch.

In one embodiment, the narrowband signal is at a frequency offset from DC. For each receive branch of the plurality of receive branches, the method further comprises frequency-shifting the narrowband signal to DC to thereby provide a frequency-shifted narrowband signal, and converting the narrowband signal or the modified version thereof from analog to digital comprises converting the frequency-shifted narrowband signal from analog to digital, thereby providing the digital narrowband signal for the receive branch. In one embodiment, frequency-shifting the narrowband signal to DC comprises frequency-shifting the narrowband signal to DC via a complex IF harmonic rejection mixer. In one embodiment, frequency-shifting the narrowband signal to DC comprises applying a configurable frequency-shift to shift the narrowband signal to DC.

In another embodiment, a receiving node for a wireless system comprises a plurality of antenna elements or antenna sub-arrays and a plurality of receive branches. Each receive branch of the plurality of receive branches comprises a RFE, down-conversion circuitry, filtering circuitry, frequency-shifting circuitry, and ADC circuitry. The RFE has an input coupled to a respective one of the plurality of antennas or antenna sub-arrays and an output. The RFE of the receive branch is configured to output a wideband RF signal at the output of the RFE, the wideband RF signal comprising a narrowband RF signal. The down-conversion circuitry is configured to down-convert the wideband RF signal to baseband based on an output of a PLL to thereby provide a wideband baseband signal for the receive branch, the wideband baseband signal comprising a narrowband signal that is a baseband version of the narrowband RF signal comprised in the wideband RF signal and is at a frequency offset from DC. The filtering circuitry is configured to filter the wideband baseband signal for the receive branch to attenuate in-band and out-of-band interference and thereby provide a filtered wideband baseband signal for the receive branch, wherein the filtered wideband baseband signal for the receive branch comprises the narrowband signal that is at the frequency offset from DC. The frequency-shifting circuitry is configured to shift the narrowband signal to DC to provide a frequency-shifted narrowband signal, and the ADC circuitry is configured to convert the frequency-shifted narrowband signal from analog to digital, thereby providing a digital narrowband signal for the receive branch.

In one embodiment, the receiving node further comprises digital processing circuitry configured to receive the digital narrowband signals provided by the plurality of receive branches and perform, based on the digital narrowband signals provided by the plurality of receive branches, a narrowband beam scan procedure by which a plurality of beam directions are simultaneously scanned and one of the plurality of beam directions is selected. In one embodiment, the plurality of receive branches further comprise wideband analog beam steering components configured to apply analog beam steering in the one of the plurality of beam directions selected by the digital processing circuitry. In another embodiment, each receive branch of the plurality of receive branches further comprises phase rotation circuitry configured to apply a phase rotation to the filtered wideband baseband signal, wherein, during reception of a subsequent wideband signal, the phase rotations of the phase rotations circuitries of the plurality of receive branches are configured to receive the subsequent wideband signal at the one of the plurality of beam directions selected by the digital processing circuitry.

In one embodiment, the frequency-shifting circuitry comprises a complex IF harmonic rejection mixer.

In one embodiment, a frequency-shift applied by the frequency-shift circuitry is configurable.

In one embodiment, the receiving node is a base station. In another embodiment, a receiving node is a UE.

Corresponding embodiments of a method performed by a receiving node are also disclosed. In one embodiment, a method performed by a receiving node for a wireless system wherein the receiving node comprises a plurality of antenna elements or antenna sub-arrays and a plurality of receive branches comprises, for each receive branch of the plurality of receive branches: receiving a wideband RF signal via a respective antenna element or antenna sub-array, the wideband RF signal comprising a narrowband RF signal; down-converting the wideband RF signal to baseband based on an output of a PLL to thereby provide a wideband baseband signal for the receive branch, the wideband baseband signal comprising a narrowband signal that is a baseband version of the narrowband RF signal comprised in the wideband RF signal and is at a frequency offset from DC; filtering the wideband baseband signal for the receive branch to attenuate in-band and out-of-band interference and thereby provide a filtered wideband baseband signal for the receive branch, the filtered wideband baseband signal for the receive branch comprising the narrowband signal that is at the frequency offset from DC; frequency-shifting the narrowband signal to DC to provide a frequency-shifted narrowband signal; and converting the frequency-shifted narrowband signal from analog to digital, thereby providing a digital narrowband signal for the receive branch.

In one embodiment, the method further comprises performing, based on the digital narrowband signals provided by the plurality of receive branches, a narrowband beam scan procedure by which a plurality of beam directions are simultaneously scanned and one of the plurality of beam directions is selected. In one embodiment, the method further comprises applying analog beam steering in the one of the plurality of beam directions selected by the digital processing circuitry.

In one embodiment, frequency-shifting the narrowband signal to DC comprises frequency-shifting the narrowband signal to DC via a complex IF harmonic rejection mixer.

In one embodiment, frequency-shifting the narrowband signal to DC comprises applying a configurable frequency-shift to shift the narrowband signal to DC.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of beam steering in a wireless system;

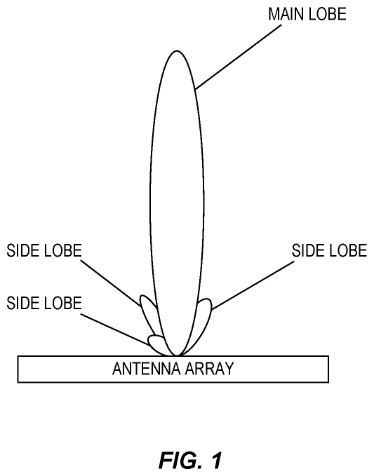

FIG. 2 illustrates one example of a wireless system in which embodiments of the present disclosure may be implemented;

FIG. 3 illustrates the receiving (RX) node of FIG. 2 in accordance with an embodiment of the present disclosure;

FIG. 4 illustrates the RX node in more detail in accordance with one embodiment of the present disclosure;

FIG. 5A illustrates the RX node in more detail in accordance with another embodiment of the present disclosure;

FIG. 5B illustrates various internal signals within the architecture of FIG. 5A;

FIG. 6A illustrates the RX node in more detail in accordance with another embodiment of the present disclosure;

FIG. 6B illustrates various internal signals within the architecture of FIG. 6A;

FIG. 7A illustrates the RX node in more detail in accordance with another embodiment of the present disclosure;

FIG. 7B illustrates various internal signals within the architecture of FIG. 7A;

FIG. 8A illustrates the RX node in more detail in accordance with another embodiment of the present disclosure;

FIG. 8B illustrates various internal signals within the architecture of FIG. 8A;

FIG. 9 illustrates one example embodiment of the digital narrowband beam scan function of FIGS. 4, 5A, 6A, 7A, and 8A; and

FIG. 10 is a flow chart that illustrates the operation of the RX node in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Systems and methods are disclosed herein that combine a narrowband (NB) digital beam steering receiver and a wideband (WB) analog beam steering receiver (i.e., a phased array system) in which the NB digital beam steering receiver is utilized to scan the full spatial domain (i.e., all angles) in one shot by using beam steering weight combinations for all directions simultaneously. Once the scan is complete, a desired beam angle of arrival is known. Beam steering weights for the wideband analog beam steering receiver are derived based on the known desired beam angle of arrival. As a result, the beam scanning process takes much less time compared to regular analog beam scanning and may happen concurrently with regular data and control reception using the WB analog beam steering receiver.

While not being limited by or to any particular advantage, embodiments disclosed herein may provide one or more of the following advantages. Embodiments of the present disclosure may provide background beam estimation, or scanning, without interruption of regular reception or transmission. Doing so maximizes throughput. In addition, it also enables frequent updates of the beam steering weights, which is beneficial for maintaining an optimal channel in a high mobility system. Embodiments of the present disclosure may also enable beam angle of arrival estimation from NB data (e.g., reference signals), which allows for simultaneous processing of the full spatial domain in a power efficient way, yet with high accuracy. Embodiments of the present disclosure may use NB digital paths, which enables requirements on data interfaces to be relaxed as compared to those needed for data sample rates or bus widths in a WB digital beam forming system.

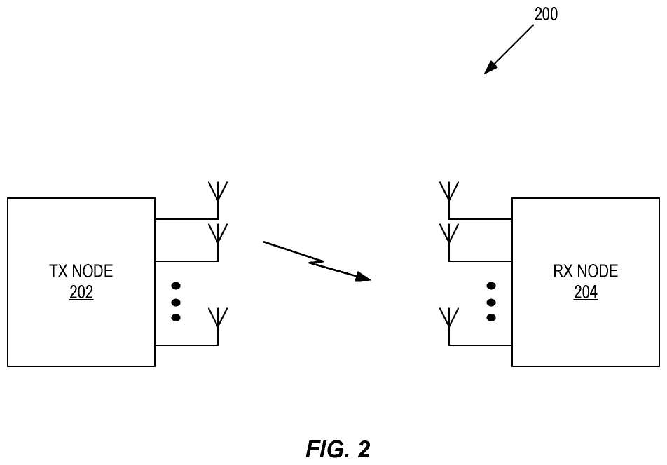

FIG. 2 illustrates one example of a wireless system 200 in which embodiments of the present disclosure may be implemented. The wireless system 200 includes a transmitting (TX) node 202 and a receiving (RX) node 204. As an example, the TX node 202 may be a base station or similar Radio Access Network (RAN) node in a cellular communications system (e.g., a Third Generation Partnership Project (3GPP) Fifth Generation System (5GS)), and the RX node 204 may be a User Equipment (UE) or similar wireless communication device in the cellular communications system. As another example, the TX node 202 may be a UE or similar wireless communication device in a cellular communications system (e.g., a 5GS), and the RX node 204 may be a base station or similar RAN node in the cellular communications system. However, these are only examples. Embodiments of the present disclosure may be used in any wireless system in which the RX node 204 uses analog beam steering.

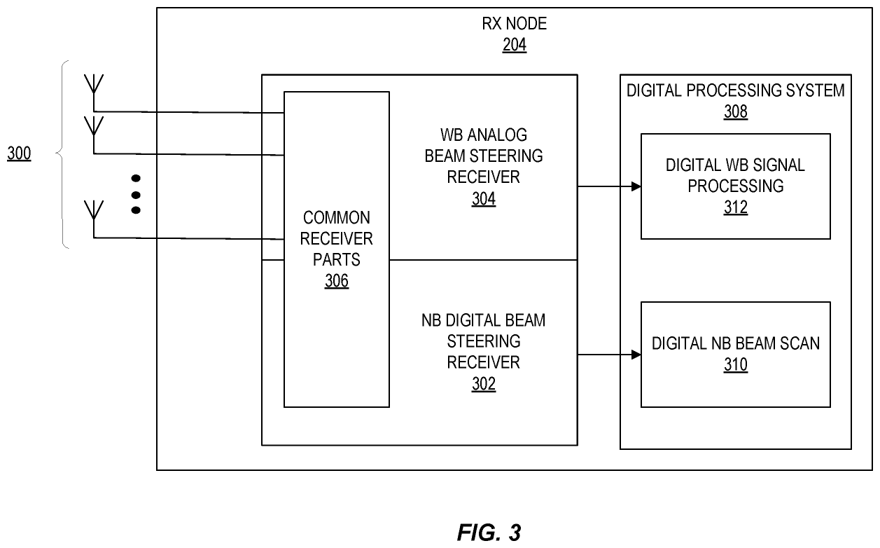

As discussed below, the RX node 204 uses analog beam steering during signal reception. As illustrated in FIG. 3, embodiments are disclosed herein in which the RX node 204 includes an antenna array 300 and both a NB digital beam steering receiver 302 and a WB analog beam steering receiver 304. As discussed below, the NB digital beam steering receiver 302 is utilized to perform NB beam scanning in multiple beam directions (e.g., all possible beam directions) using known NB signals (e.g., reference signals) that are located at known frequency location within the total bandwidth of a desired WB signal received via the WB analog beam steering receiver 304. For example, the total bandwidth of the described WB signal may be tens or hundreds of Megahertz (MHz), and the NB signal(s) received via the NB digital beam steering receiver 302 may have a bandwidth that is significantly less than that of the desired WB signal (e.g., a few hundred kilohertz (kHz), a few MHz, tens of MHz, or the like). In one example embodiment, the bandwidth of the NB signal(s) is at least an order of magnitude less than the bandwidth of the WB signal (e.g., if the bandwidth of the WB signal is 400 MHz, then the bandwidth of the NB signal is 40 MHz, or less). In another example embodiment, the bandwidth of the NB signal is less than ⅕^{th} of the bandwidth of the WB signal. Note that this applies to the digital NB signal as well. By using known NB signals, the NB digital beam steering receiver 302 is used to perform simultaneous beam scanning of multiple (e.g., all possible) beam directions in a quick and power efficient manner.

In the example embodiments described herein, the RX node 204 includes common receiver parts 306 (e.g., radio front end (RFE) circuity such as Low-Noise Amplifiers (LNAs), filters, etc., downconversion circuitry, etc.) that are common to both the NB digital beam steering receiver 302 and the WB analog beam steering receiver 304. The RX node 204 also includes a digital processing system 308 that includes a digital NB beam scan function 310 and a digital WB signal processing function 312. The digital processing system 308 includes circuity (e.g., one or more Digital Signal Processors (DSPs) or the like). The digital beam scan function 310 and the digital WB signal processing function 312 may be implemented in the same or different circuitry (e.g., in the same or different DSPs). The NB digital beam steering receiver 302 is utilized by the NB beam scan function 310 of the digital processing system 308 to scan at least a portion of (e.g., all of) the spatial domain (i.e., all angles) in one shot by using beam steering weight combinations for the at least a portion of all possible beam directions simultaneously. Note that, in one embodiment, the digital processing system 308 scans the full spatial domain (i.e., all beam directions) simultaneously. In another embodiment, the digital processing system 308 scans multiple beams simultaneously, where one or more such simultaneous beam scans may be used to scan the full spatial domain (i.e., to scan all beam directions). Once the scan is complete, a desired beam angle of arrival is known. The digital processing system 308 derives beam steering weights for the WB analog beam steering receiver 304 based on the known desired beam angle of arrival and configures the WB analog beam steering receiver 304 with the derived beam steering weights. As a result, the beam scanning process takes much less time compared to regular analog beam scanning and may happen concurrently with regular data and control reception using the WB analog beam steering receiver.

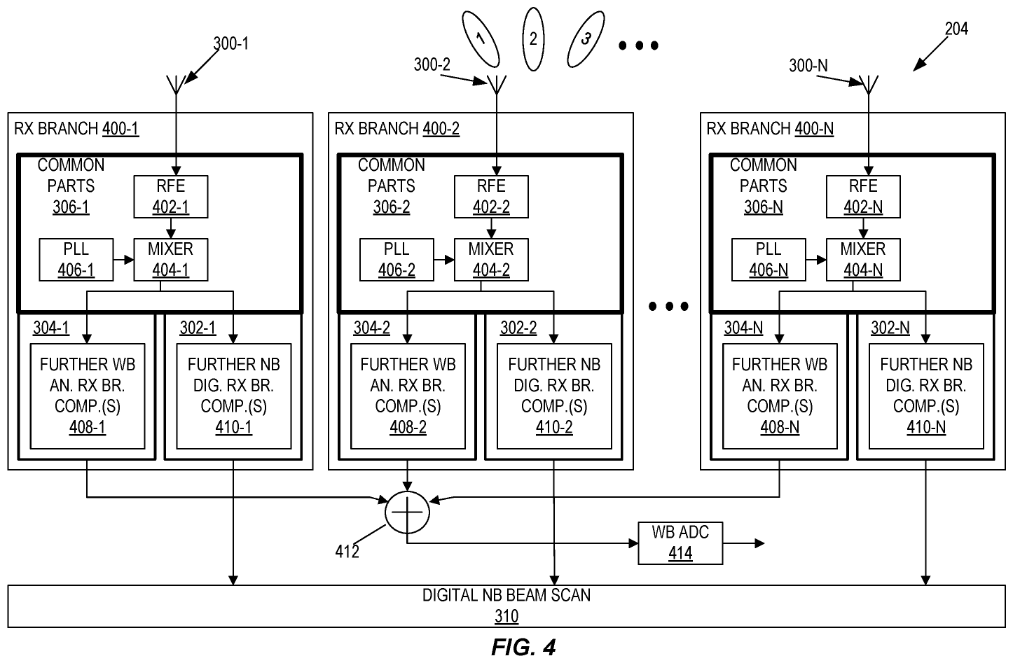

FIG. 4 illustrates the RX node 204 in more detail in accordance with one embodiment of the present disclosure. As illustrated, the antenna array 300 includes multiple antenna elements 300-1 through 300-N coupled to respective receiver branches 400-1 through 400-N. Note that an arbitrary one of the antenna elements 300-1 through 300-N is referred to herein as antenna element 300-i. Likewise, an arbitrary one of the receiver branches 400-1 through 400-N is referred to herein as receiver branch 400-i. Also note that each antenna element 300-i may be a single antenna element or a subarray including two or more individual antenna elements.

Each receiver branch 400-i includes a respective branch of the NB digital beam steering receiver 302, which is referred to herein as a NB digital beam steering receiver branch 302-i, and a respective branch of the WB analog beam steering receiver 304, which is referred to herein as a WB analog beam steering receiver branch 304-i. For each receiver branch 400-i, common parts 306-i (part of the common parts 306) are shared by the NB digital beam steering receiver 302 and the WB analog beam steering receiver 304.

In this example, for each receiver branch 400-i, the common parts 306-i include a radio front end (RFE) 402-i, a mixer 404-i, and a phase-locked loop (PLL) 406-i, arranged as shown. As will be appreciated by one of ordinary skill in the art, the RFE 402-i includes various components such as, e.g., an LNA, a filter(s), etc. The mixer 404-i and the PLL 406-i form downconversion circuitry that operates to downconvert a WB RF signal received at the respective antenna element 300-i and output by the RFE 402-i from the receive frequency (e.g., radio frequency (RF)) to baseband, thereby providing an analog WB signal at baseband. The analog WB receive signal is then processed in parallel by both further components 408-i of the NB digital beam steering receiver branch 302-i and further components 410-i of the WB analog beam steering receiver branch 304-i.

Digital NB receive signals output by the NB digital beam steering receiver branches 302-1 through 302-N are processed by the digital NB beam scan function 310 to perform simultaneous scanning of multiple (e.g., all possible) beam directions to find the best, or desired, RX beam direction. In other words, multiple (e.g., all possible) beam directions may be detected, or scanned, simultaneously by deploying digital beamforming as the full spatial domain can be processed simultaneously. More precisely a set of beam steering weight combinations for multiple (e.g., all) beam directions may be applied to the same set of digital NB receive signals, which avoids the need to scan or detect one beam direction at a time. This operation does not depend on user data, but rather on a known NB signal(s) (e.g., a reference signal(s)), transmitted at known frequency locations within the overall bandwidth of the WB signal. Thus, the digital beamforming can be made NB and power efficient. Examples of reference signals in a 3GPP 5GS that may be used for this digital NB beam scanning include, e.g., Synchronization Signal Block (SSB), PRACH (Physical Random Access Channel), Channel State Information Reference Signal (CSI-RS), Common Reference Signal (CRS), Sounding Reference Signal (SRS), and the like. By tapping off parts of the received signal carrier that is allocated for the signal components of interest (e.g., reference signals) from each antenna port, lean digital processing is possible to determine the baseband rotation weights for the WB analog beam steering reception for a respective transmitting source. The beam steering weights to use may be selected based on at least one metric including, e.g., Signal to Noise Ratio (SNR), Signal to Interference plus Noise Ratio (SINR), Received Strength of Signal Indicator (RSSI), or the like.

At the same time, analog WB receive signals output by the WB analog beam steering receiver branches 304-1 through 304-N are combined by combiner circuitry 412, and the resulting combined analog WB receive signal is then analog-to-digital converted by an analog-to-digital converter (ADC) 414. The resulting digital WB receive signal is then processed by the digital WB signal processing function 312 of the digital processing system 308 of the RX node 204 (e.g., to extract data and/or control information contained in the digital WB receive signal).

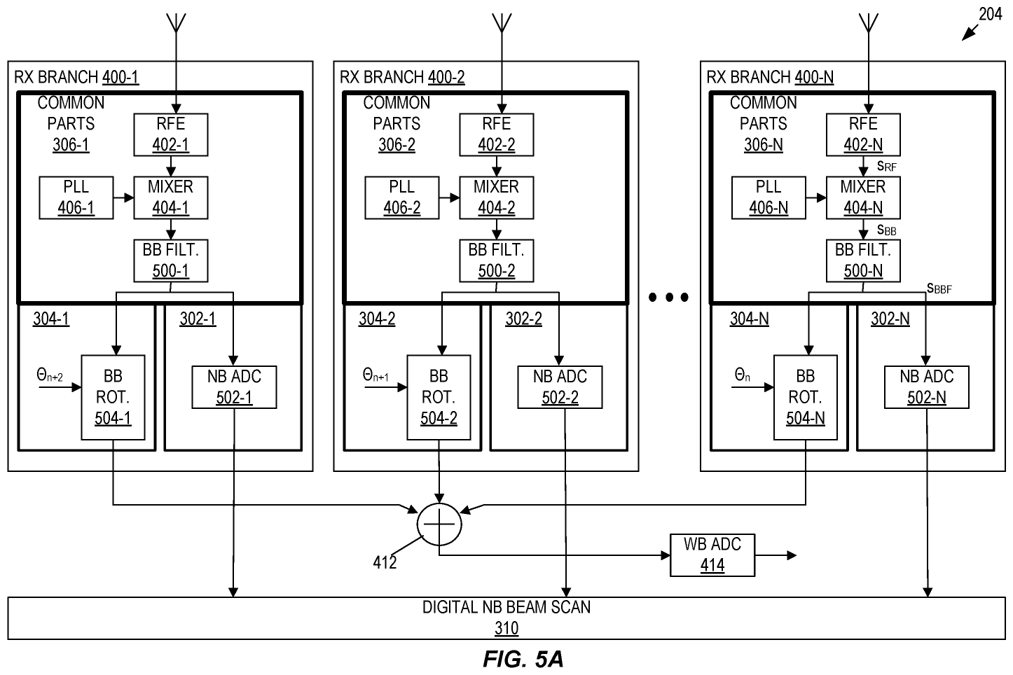

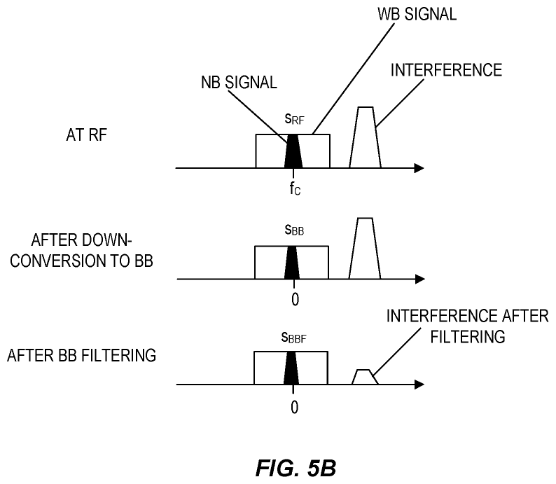

FIG. 5A shows an example embodiment of the RX node 204. More specifically, FIG. 5A shows an example embodiment in which, for each receiver branch 400-i, the common parts 306-i include the RFE 402-i, the mixer 404-i, the PLL 406-i as described above and further include a baseband (BB) filter 500-i, where these elements are arranged as shown. In addition, in this example, the NB digital beam steering receiver branch 302-i includes, in addition to the common parts 306-i, a NB ADC 502-i. In this example, the WB analog beam steering receiver branch 304-i includes a BB rotation function 504-i, which applies a desired phase rotation for the WB analog beam steering receiver branch 304-i.

In operation, for each receiver branch 300-i, the RF signal received via the respective antenna element 300-i is processed by the RFE 402-i and downconverted, by the mixer 404-i and PLL 406-i, to a baseband signal represented by an IQ signal pair, and then filtered by the BB filter 500-i to attenuate in-band and out-of-band interference. Here, the analog beam steering of the WB analog beam steering receiver 304 is performed in the baseband domain. More specifically, for each WB analog beam steering receiver branch 304-i, the BB rotation circuitry 504-i applies an IQ signal rotation to the filtered BB signal, wherein in this case the beam-forming weights correspond to phase shifting the equivalent RF signal with a phase θ. For the NB digital beam steering receiver branch 302-i, the downconverted signal is passed on to the NB ADC 502-i. The NB ADC 502-i has enough bandwidth to process the NB signal, which for this example is assumed to be allocated around DC, with a bandwidth substantially less than that of the WB carrier. Optionally, the NB ADC 502-i may be preceded by an antialiasing filter that passes the NB signal while suppressing any other signals present outside the NB signal. Thus, concurrent scanning and reception is possible which is a great advantage for mobility and fast changing radio environments.

FIG. 5B illustrates the various signals present in the architecture of FIG. 5A, namely, the RF signal (s_{RF}) output by the RFE 402-i, the baseband signal (s_{BB}) output by the mixer 404-i, and the filtered baseband signal (s_{BBF}) output by the BB filter 500-i.

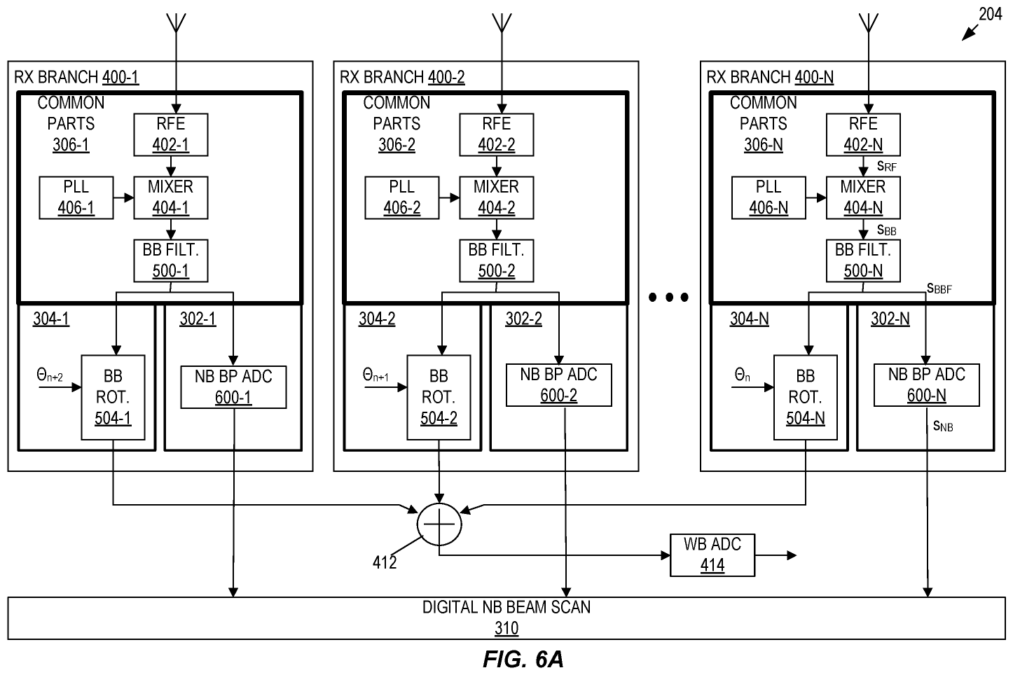

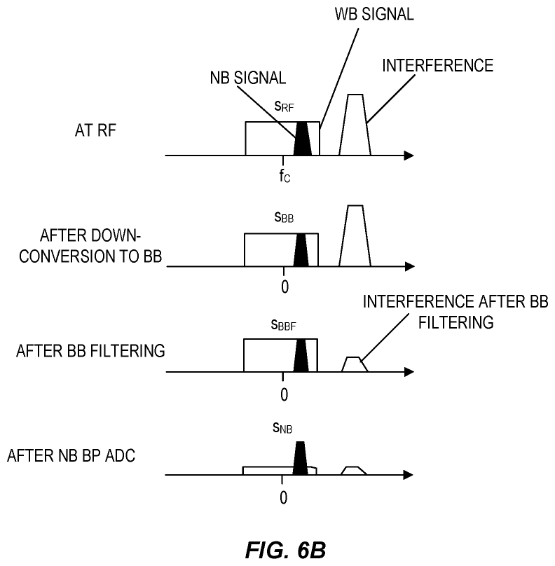

FIG. 6A illustrates another example embodiment of the RX node 204. This embodiment is substantially the same as that of FIG. 5A but where the BB ADC 502-i is replaced with a NB bandpass (BP) ADC 600-i (i.e., a NB ADC having a bandpass characteristic). In this example, the NB signal is offset from the center frequency of the WB carrier and, as such, the NB signal is offset from DC after downconversion. The NB BP ADC 600-i has a bandpass characteristic that passes the NB signal but suppresses other frequency components.

FIG. 6B illustrates the various signals present in the architecture of FIG. 6A, namely, the RF signal (s_{RF}) output by the RFE 402-i, the baseband signal (s_{BB}) output by the mixer 404-i, the filtered baseband signal (s_{BBF}) output by the BB filter 500-i, and the narrowband signal output by the NB BP ADC 600-i.

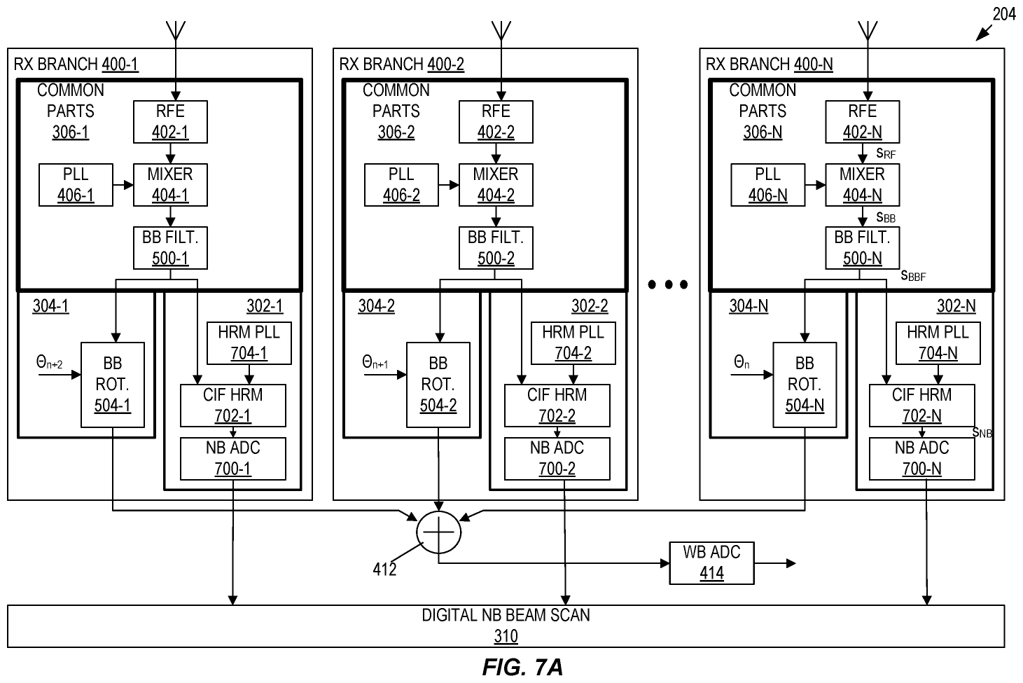

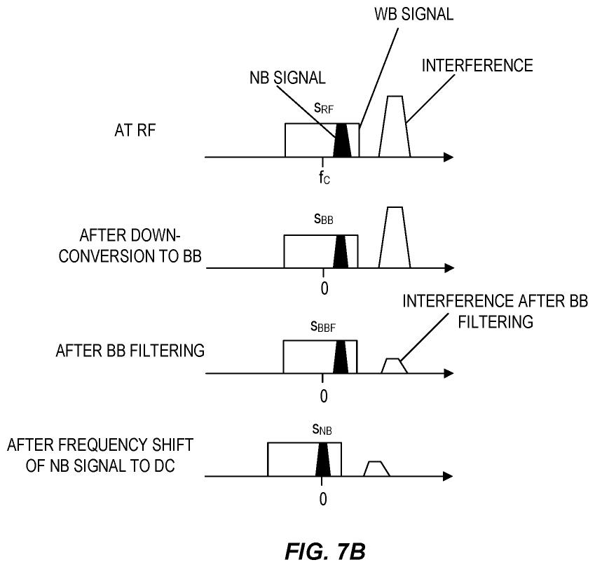

FIG. 7A illustrates another example embodiment of the RX node 204. This embodiment is similar to that of FIGS. 5A and 5B, but includes a different architecture for the NB digital beam steering receiver branch 302-i. Here, it is again assumed that the NB signal may be allocated somewhere within the WB carrier bandwidth, and is not restricted to be centered around DC after downconversion. But, instead of using an ADC with a bandpass characteristic as is done in the embodiment of FIG. 7A, a NB ADC 700-i is used and preceded by a (complex) harmonic rejection mixer (HRM) 702-i that shifts the entire baseband signal spectrum such that the NB signal is shifted to around DC (i.e., to overlap DC, e.g., to be centered at DC). The frequency shift applied by the HRM 702-i is controlled by a PLL, which is referred to here as a HRM PLL 704-i. Note that the frequency of the HRM PLL 704-i may, in some embodiment, be controlled or changed to accommodate NB signals at different frequency locations within the WB carrier bandwidth. Again, while note illustrated in FIG. 7A, the NB ADC 700-i may optionally be preceded by an antialiasing filter. To support a range of reference signal allocations, the HRM 702-i is reconfigurable (via control of the output frequency of the HRM PLL 704-i) to support different downconversion frequencies. Note that the HRM 702-i is desired as opposed to regular mixing as regular mixing also frequency translates the parts of the baseband signal spectrum around the harmonics of the fundamental frequency of frequency shift.

FIG. 7B illustrates the various signals present in the architecture of FIG. 7A, namely, the RF signal (s_{RF}) output by the RFE 402-i, the baseband signal (s_{BB}) output by the mixer 404-i, the filtered baseband signal (s_{BBF}) output by the BB filter 500-i, and the narrowband signal output by the NB ADC 700-i.

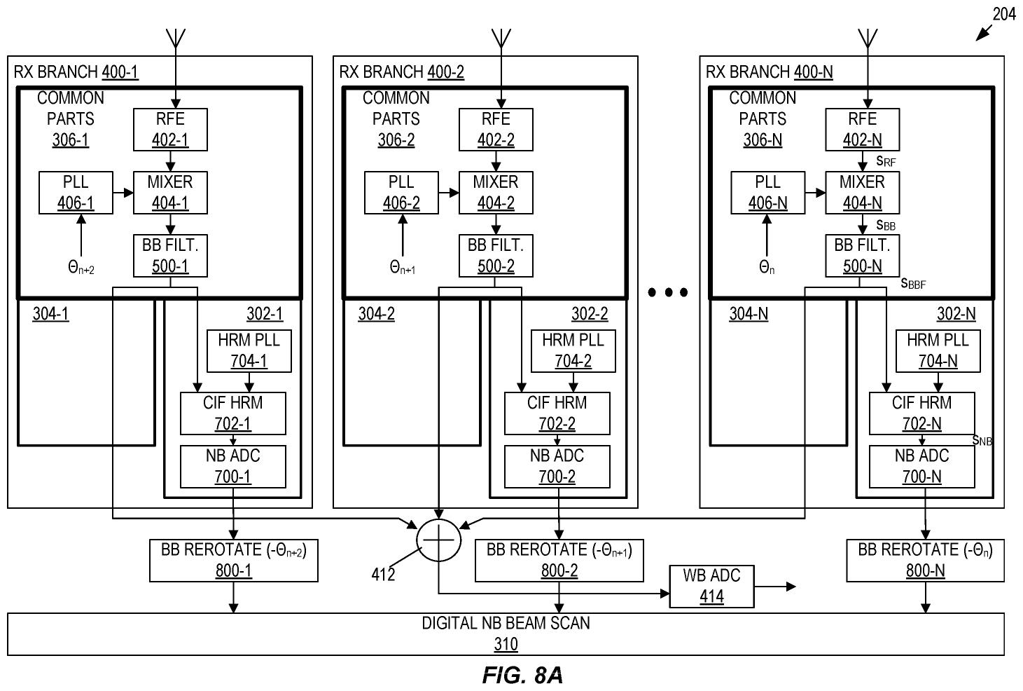

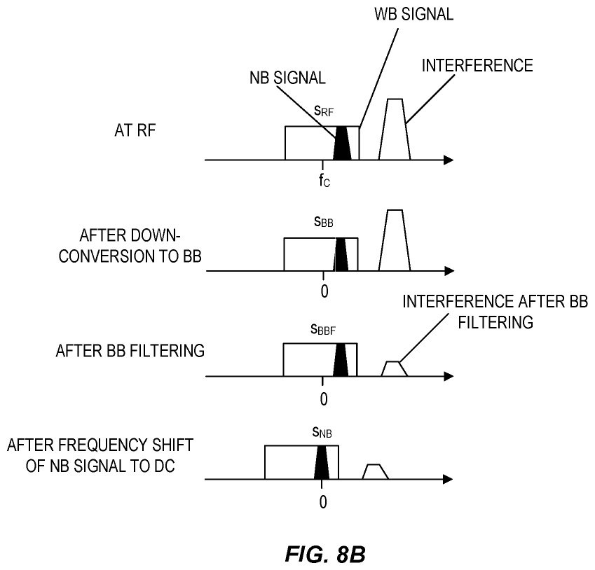

FIG. 8A illustrates another example embodiment of the RX node 204. This embodiment is similar to that of FIG. 7A but where the analog beam steering (phase only) takes place by adjusting the phase of the PLL 406-i used for downconversion, thereby avoiding the baseband rotation. As the NB digital beam steering receiver branch 302-i includes the PLL 406-i, which is now being used for the phase rotation for the analog beam steering, the NB digital baseband signal output by the NB digital beam steering receiver branch 302-i is, in this embodiment, de-rotated back with the same amount of phase rotation applied at the PLL 406-i. This is preferably done by respective BB re-rotation circuitry 800-i in the digital domain as shown in FIG. 8A, but may alternatively be embedded in the phase of the Local Oscillator (LO) used by the HRM PLL 704-i or in the output frequency of the HRM PLL 704-i.

Note that while the analog WB beam steering via the PLLs 406-1 through 406-N is shown in FIG. 8A in combination with the HRMs 702-1 through 702N, analog WB beam steering via the PLLs 406-1 through 406-N can be used together with other variations of the NB digital beam steering receiver branches 302-1 through 302-N (e.g., in combination with the variation in FIG. 5A or the variation shown in FIG. 6A).

FIG. 8B illustrates the various signals present in the architecture of FIG. 8A, namely, the RF signal (s_{RF}) output by the RFE 402-i, the baseband signal (s_{BB}) output by the mixer 404-i, the filtered baseband signal (s_{BBF}) output by the BB filter 500-i, and the narrowband signal output by the NB ADC 700-i.

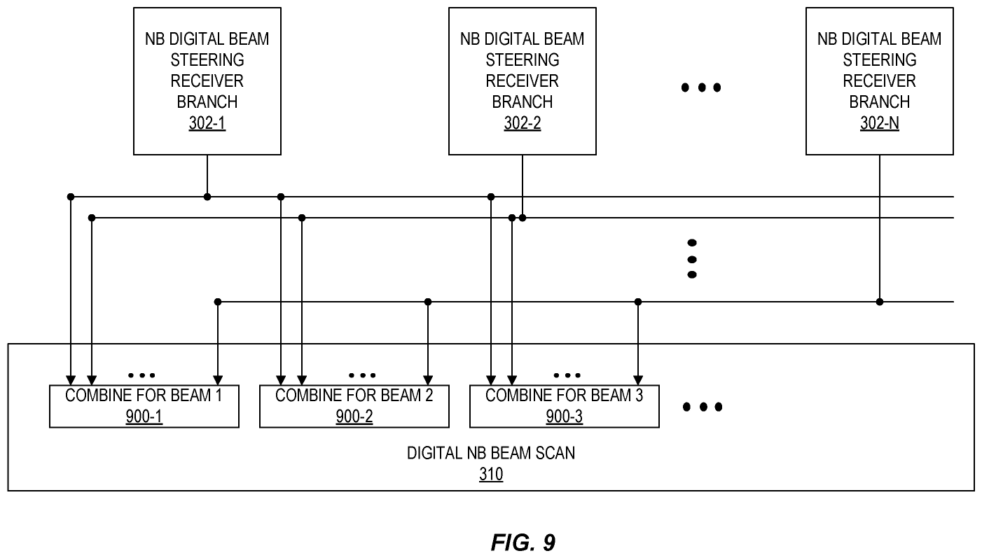

FIG. 9 illustrates one example embodiment of the digital NB beam scan function 310. In this example, the digital NB beam scan function 310 includes combining functions 900-1 through 900-B that combine the NB digital receive signals output by the NB digital beam steering receiver branches 302-1 through 302-N in accordance with beam steering weights for B beam directions simultaneously to provide a separate combined signal for each of the B beam directions. The digital NB beam scan function 310 may then further process the B combined signals (e.g., compute SNR, SINR, or RSSI) and used the results of this processing to select the “best” beam direction (e.g., the beam direction that corresponds to the highest SNR, SINR, or RSSI). The digital processing system 308 may then configure the WB analog beam steering receiver 304 (e.g., by configuring the phase rotations for each branch of the WB analog beam steering receiver 304 or by configuring the PLL 406-i when WB analog beam steering is performed via the PLLs 406-i) to apply analog beam steering in the selected beam direction.

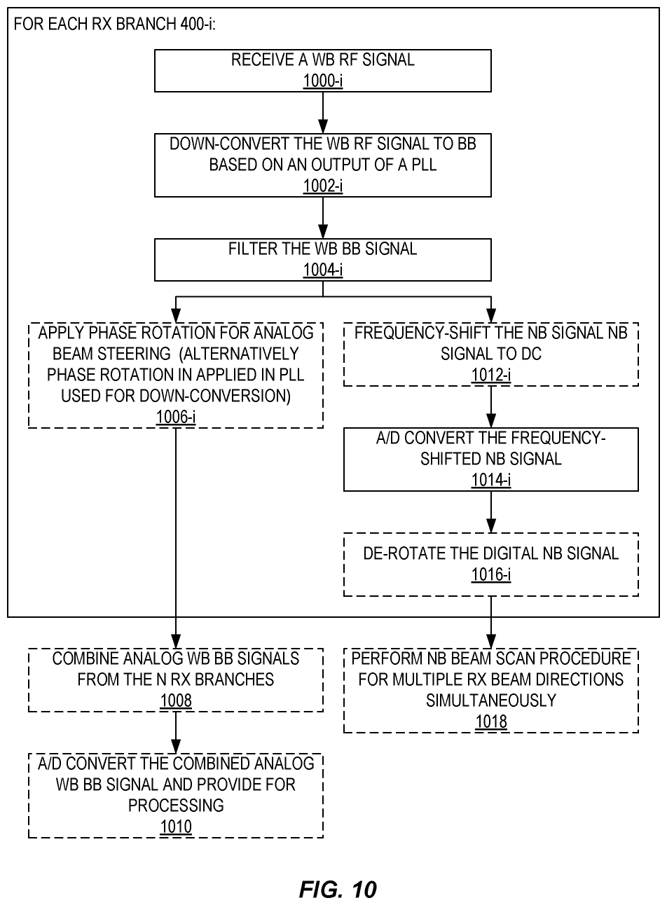

FIG. 10 is a flow chart that illustrates the operation of the RX node 204 in accordance with the embodiments described above. As illustrated, for each RX branch 400-i, the RX branch 400-i receives a WB RF signal via a respective antenna element or antenna sub-array 300-i (step 1000-i), down-coverts the WB RF signal to baseband based on an output of the PLL 406-i to thereby provide a WB BB signal for the receive branch 400-i (step 1002-i), and filters the WB BB signal for the receive branch 400-i to provide a filtered WB BB signal for the receive branch 400-i, where the filtered WB BB signal for the receive branch 400-i includes a NB (step 1004-i). In some embodiments, the NB signal that is at a frequency offset from DC.

The WB analog beam steering receiver branch 304-i then, in some embodiments, applies a corresponding phase rotation to the filtered WB BB signal for analog beam steering (step 1006-i). Alternatively, as described above, the phase rotation for analog beam steering is applied at the output of the PLL 406-i used for down-conversion. The WB BB signals output by the WB analog beam steering receiver branches 304-1 through 304-N are combined (step 1008), and the resulting combined WB BB signal is analog-to-digital (A/D) converted (step 1010). The digital combined WB BB signal may then be further processed (e.g., by the digital WB signal processing function 312).

In parallel, the NB digital beam steering receiver branch 302-i processes the filtered WB BB signal. More specifically, if the NB signal is offset from DC, the NB digital beam steering receiver branch 302-i frequency-shifts the NB signal to DC (step 1012-i). This may be done via, e.g., the CIF HRM 702-2 and HRM PLL 704-2. The (potentially frequency-shifted) NB signal is A/D converted (e.g., via NB ADC 502-i or NB BP ADC 600-i or NB ADC 700-i) (step 1014-i). Further, if the phase rotation for analog beam steering was applied at the PLL 406-i used for down-conversion, the digital NB signal is de-rotated (i.e., an opposite phase rotation is applied to the digital NB signal) (step 1016-i). The NB beam scanning procedure is then performed based on the digital NB signals output by the NB digital beam steering receiver branches 302-1 through 302-N (1018). As described above, the NB beam scanning procedure simultaneously scans multiple (e.g., all) RX beams to determine the best RX beam for the RX node 204. The WB analog beam steering receiver branches 304-1 through 304-N may then be configured to apply analog beam steering (via configuring their phase rotations) in the best RX beam direction.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A receiving node for a wireless system, the receiving node comprising:
a plurality of antenna elements or antenna sub-arrays;
a plurality of receive branches, wherein each receive branch of the plurality of receive branches comprises:
a radio front-end, RFE, having an input coupled to a respective one of the plurality of antennas or antenna sub-arrays and an output, the RFE of the receive branch configured to output a wideband radio frequency, RF, signal at the output of the RFE, the wideband RF signal comprising a narrowband RF signal;
a phase-locked loop, PLL, configured to provide a PLL output;
down-conversion circuitry configured to down-convert the wideband RF signal to baseband based on the PLL output of the PLL to thereby provide a wideband baseband signal for the receive branch, the wideband baseband signal comprising a narrowband signal that is a baseband version of the narrowband RF signal comprised in the wideband RF signal;
filtering circuitry configured to filter the wideband baseband signal for the receive branch to attenuate in-band and out-of-band interference and thereby provide a filtered wideband baseband signal for the receive branch, the filtered wideband baseband signal for the receive branch comprising the narrowband signal; and
analog-to-digital conversion, ADC, circuitry configured to convert the narrowband signal or a modified version thereof from analog to digital, thereby providing a digital narrowband signal for the receive branch;
wherein the PLLs of the plurality of receive branches are configured to apply respective phase rotations for wideband analog beam steering.

2. The receiving node of claim 1 further comprising digital processing circuitry configured to receive the digital narrowband signals provided by the plurality of receive branches and perform, based on the digital narrowband signals provided by the plurality of receive branches, a narrowband beam scan procedure by which a plurality of beam directions are simultaneously scanned and one of the plurality of beam directions is selected.

3. The receiving node of claim 2 wherein the phase rotations applied by the PLLs are configured to apply wideband analog beam steering in the one of the plurality of beam directions selected by the digital processing circuitry.

4. The receiving node of claim 2 wherein:
each receive branch of the plurality of receive branches further comprises phase rotation circuitry configured to apply a second phase rotation to the digital narrowband signal for the receive branch, the second phase rotation being the opposite of the phase rotation applied by the respective PLL.

5. The receiving node of claim 4 wherein, during reception of a subsequent wideband signal, the phase rotations applied by the PLLs of the plurality of receive branches are configured so as to receive the subsequent wideband signal at the one of the plurality of beam directions selected by the digital processing circuitry.

6. The receiving node of claim 1 wherein:
the narrowband signal is at a frequency offset from DC;
each receive branch of the plurality of receive branches further comprises frequency-shifting circuitry configured to frequency-shift the narrowband signal to DC to thereby provide a frequency-shifted narrowband signal; and
the ADC circuitry is configured to convert the frequency-shifted narrowband signal from analog to digital, thereby providing the digital narrowband signal for the receive branch.

7. The receiving node of claim 6 wherein the frequency-shifting circuitry comprises a complex intermediate frequency, IF, harmonic rejection mixer.

8-10. (canceled)

11. A method performed by a receiving node for a wireless system wherein the receiving node comprises a plurality of antenna elements or antenna sub-arrays and a plurality of receive branches, the method comprising:
for each receive branch of the plurality of receive branches:
receiving a wideband radio frequency, RF, signal via a respective antenna element or antenna sub-array, the wideband RF signal comprising a narrowband RF signal;
down-converting the wideband RF signal to baseband based on an output of a separate phase-locked loop, PLL, for the receive branch to thereby provide a wideband baseband signal for the receive branch, the wideband baseband signal comprising a narrowband signal that is a baseband version of the narrowband RF signal comprised in the wideband RF signal;
filtering the wideband baseband signal for the receive branch to attenuate in-band and out-of-band interference and thereby provide a filtered wideband baseband signal for the receive branch, the filtered wideband baseband signal for the receive branch comprising the narrowband signal; and
converting the narrowband signal or a modified version thereof from analog to digital, thereby providing a digital narrowband signal for the receive branch;
wherein wideband analog beam steering is applied via configuration of phase rotations of the PLL outputs of the PLLs of the plurality of receive branches.

12. The method of claim 11 further comprising performing, based on the digital narrowband signals provided by the plurality of receive branches, a narrowband beam scan procedure by which a plurality of beam directions are simultaneously scanned and one of the plurality of beam directions is selected.

13. The method of claim 12 further comprising applying analog beam steering in the one of the plurality of beam directions selected by the digital processing circuitry via configuration of the phase rotations of the separate PLLs.

14. The method of claim 12 further comprising:
for each receive branch of the plurality of receive branches, applying a second phase rotation to the digital narrowband signal for the receive branch that is the opposite of the phase rotation applied by the separate PLL for the receive branch.

15. The method of claim 11 wherein:
the narrowband signal that is at a frequency offset from DC;
for each receive branch of the plurality of receive branches, the method further comprises frequency-shifting the narrowband signal to DC to thereby provide a frequency-shifted narrowband signal; and
converting the narrowband signal or the modified version thereof from analog to digital comprises converting the frequency-shifted narrowband signal from analog to digital, thereby providing the digital narrowband signal for the receive branch.

16. The method of claim 15 wherein frequency-shifting the narrowband signal to DC comprises frequency-shifting the narrowband signal to DC via a complex intermediate frequency, IF, harmonic rejection mixer.

17. The method of claim 15 wherein frequency-shifting the narrowband signal to DC comprises applying a configurable frequency-shift to shift the narrowband signal to DC.

18. A receiving node for a wireless system, the receiving node comprising:
a plurality of antenna elements or antenna sub-arrays;
a plurality of receive branches, wherein each receive branch of the plurality of receive branches comprises:
a radio front-end, RFE, having an input coupled to a respective one of the plurality of antennas or antenna sub-arrays and an output, the RFE of the receive branch configured to output a wideband radio frequency, RF, signal at the output of the RFE, the wideband RF signal comprising a narrowband RF signal;
down-conversion circuitry configured to down-convert the wideband RF signal to baseband based on an output of a phase-locked loop, PLL, to thereby provide a wideband baseband signal for the receive branch, the wideband baseband signal comprising a narrowband signal that is a baseband version of the narrowband RF signal comprised in the wideband RF signal and is at a frequency offset from DC;
filtering circuitry configured to filter the wideband baseband signal for the receive branch to attenuate in-band and out-of-band interference and thereby provide a filtered wideband baseband signal for the receive branch, the filtered wideband baseband signal for the receive branch comprising the narrowband signal that is at the frequency offset from DC;
frequency-shifting circuitry configured to shift the narrowband signal to DC to provide a frequency-shifted narrowband signal; and
analog-to-digital conversion, ADC, circuitry configured to convert the frequency-shifted narrowband signal from analog to digital, thereby providing a digital narrowband signal for the receive branch.

19-25. (canceled)

26. A method performed by a receiving node for a wireless system wherein the receiving node comprises a plurality of antenna elements or antenna sub-arrays and a plurality of receive branches, the method comprising:
for each receive branch of the plurality of receive branches:
receiving a wideband radio frequency, RF, signal via a respective antenna element or antenna sub-array, the wideband RF signal comprising a narrowband RF signal;
down-converting the wideband RF signal to baseband based on an output of a phase-locked loop, PLL, to thereby provide a wideband baseband signal for the receive branch, the wideband baseband signal comprising a narrowband signal that is a baseband version of the narrowband RF signal comprised in the wideband RF signal and is at a frequency offset from DC;
filtering the wideband baseband signal for the receive branch to attenuate in-band and out-of-band interference and thereby provide a filtered wideband baseband signal for the receive branch, the filtered wideband baseband signal for the receive branch comprising the narrowband signal that is at the frequency offset from DC;
frequency-shifting the narrowband signal to DC to provide a frequency-shifted narrowband signal; and
converting the frequency-shifted narrowband signal from analog to digital, thereby providing a digital narrowband signal for the receive branch.

27. The method of claim 26 further comprising performing, based on the digital narrowband signals provided by the plurality of receive branches, a narrowband beam scan procedure by which a plurality of beam directions are simultaneously scanned and one of the plurality of beam directions is selected.

28. The method of claim 27 further comprising applying analog beam steering in the one of the plurality of beam directions selected by the digital processing circuitry.

29. The method of claim 26 wherein frequency-shifting the narrowband signal to DC comprises frequency-shifting the narrowband signal to DC via a complex intermediate frequency, IF, harmonic rejection mixer.

30. The method of claim 26 wherein frequency-shifting the narrowband signal to DC comprises applying a configurable frequency-shift to shift the narrowband signal to DC.
